(19) United States
(12) Patent Application Publication
(10) Pub. No.: US 2006/0270445 A1
(43) Pub. Date: Nov. 30, 2006

(54) Full qwerty web-phone with hidden second keypad

(76) Inventor: Ivan Miramontes, Fontana, CA (US)

Correspondence Address: SETO PATENTS, 406 RIVERLAND DR., SALEM, VA, 24153, US

(21) Appl. No.: 11/136,031

(22) Filed: May 25, 2005

(51) Int. Cl. H04M 1/00

(52) U.S. Cl. 455/550.1

(57) ABSTRACT

A web enabled personal communication device with a permanent keypad, a display screen and a second keypad. The permanent keypad provides a numeric keypad for dialing telephone numbers when the device is operated in the first mode, as a cellular telephone. The permanent keypad also presents the left half of a qwerty keyboard for data entry by the user when the device is operated in a second mode. The second keypad is hidden from view when the device is operated in the first mode, and exposed for use by the user when the device is operated in the second mode. The second keypad provides the right half of the qwerty keyboard to the user for data entry. When the device is in placed in the second mode, by exposing the second keypad, the permanent keypad functions as the left half of a qwerty keyboard. In an alternative embodiment, the second keypad can also functions as gaming controls for playing a video game.

### BACKGROUND OF THE INVENTION

The present invention relates generally to the field of web enabled cellular telephones and more specifically to a web enabled cellular telephone with a slide out second keypad.

The present invention was originally disclosed in Disclosure Document No. 566353 received at the U.S. patent office on Dec. 6, 2004, and in Disclosure Document No. 571164 received at the U.S. patent office on Feb. 24, 2005.

The first telephone was invented in 1876 by Alexander Graham Bell. The basic concept of transforming a human voice into an undulating current that is then used to reproduce the voice at a remote location is still in use today in some analog wire line systems. Advances in modern technology have added to the capabilities of the modern telephones wherein both voice and data can be carried over a telephone line in a digital form. Today, a physical telephone line today is not even a requirement as radio waves can now be used to carry voice and data. Such radio waves are used in cordless telephones found in many of today's households and also make cellular telephone systems possible.

A basic telephone set contains a transmitter that transfers the caller's voice, a receiver that amplifies sound from an incoming call, a rotary or push-button dial and, a ringer or alerter. A small assembly of electrical parts, called the anti-sidetone network that keeps the caller's voice from sounding too loud through the receiver is also included. A speakerphone has a microphone and speaker in the base in addition to the transmitter and receiver in the handset. Speakerphones allow callers' hands to be free, and allow more than two people to listen and speak during a call. In a cordless phone, the handset cord is replaced by a radio link between the handset and base, but a line cord is still used between the base and the telephone line. This allows a caller to move about in a limited area while on the telephone. A cellular phone has miniaturized components that make it possible to combine the base and handset into one handheld unit. No line or handset cord is needed with a cellular phone thereby providing maximum mobility.

A cellular telephone is designed to give the user maximum freedom of movement while using a telephone. A cellular telephone uses radio signals to communicate between the “cell phone” and a base station, via an antenna. The served area is divided into cells something like a honeycomb, and an antenna is placed within each cell and connected by telephone lines to one exchange devoted to cellular-telephone calls. This exchange connects cellular telephones to one another and transfers the call to a regular exchange, public switched telephone network, if the call is between a cellular telephone and a non-cellular telephone. The special cellular exchange, through computer control, selects the antenna closest to the telephone when service is requested. As the telephone roams, the exchange automatically determines when to change the serving cell based on the power of the radio signal received simultaneously at adjacent sites. This change occurs without interrupting conversation. Practical power considerations limit the distance between the telephone and the nearest cellular antenna, and since cellular phones use radio signals, it is possible for unauthorized people to access communications carried out over cellular phones. One of the reasons why digital cell phones have gained in popularity, besides being able to access the Internet, is because their radio signals are harder to intercept and decode.

Analog transmission, in which speech or data is converted directly into a varying electrical current, is suitable for local calls. But once the call involves any significant distance, the necessary amplification of the analog signal can add so much noise that the received signal becomes unintelligible. For long-distance calls, the signal is digitized, or converted to a series of pulses that encodes the information. When an analog electrical signal is digitized, samples of the signal's strength are taken at regular intervals, usually about 8000 samples per second. Each sample is converted into a binary form, a number made up of a series of 1s and 0s. This number is easily and swiftly passed through the switching system. Digital transmission systems are much less subject to interfering noise than are analog systems. The digitized signal can then be passed through a digital-to-analog converter (DAC) at a point close to the receiving party, and converted to a form that the ear cannot distinguish from the original signal. There are several ways a digital or analog signal may be transmitted, including coaxial and fiber-optic cables and microwave and longwave radio signals sent along the ground or bounced off satellites in orbit around the earth. A coaxial wire, like the wire between a videocassette recorder (VCR) and a television set, is an efficient transmission system. A coaxial wire has a conducting tube surrounding another conductor. A coaxial cable contains several coaxial wires in a common outer covering. The important benefit of a coaxial cable over a cable composed of simple wires is that the coaxial cable is more efficient at carrying very high frequency currents. This is important because in providing transmission over long distances, many telephone conversations are combined using frequency-modulation (FM) techniques similar to the combining of many channels in the television system. The combined signal containing hundreds of individual telephone conversations is sent over one pair of wires in a coaxial cable, so the signal has to be very clear.

Fiber optic cable offer another telephone-transmission method that uses bundles of optical fibers, long strands of specially made glass encased in a protective coating. Optical fibers transmit energy in the form of light pulses. The technology is similar to that of the coaxial cable, except that the optical fibers can handle tens of thousands of conversations simultaneously. Another approach to long-distance transmission is the use of radio. Before coaxial cables were invented, very powerful longwave (low frequency) radio stations were used for intercontinental calls. Microwave radio uses very high frequency radio waves and has the ability to handle a large number of simultaneous conversations over the same microwave link. Because cable does not have to be installed between microwave towers, this system is usually cheaper than coaxial cable. On land, the coaxial-cable systems are often supplemented with microwave-radio systems. The technology of microwave radio is carried one step further by the use of communications satellites. Most communications satellites are in geosynchronous orbit—that is, they orbit the earth once a day over the equator, so the satellite is always above the same place on the earth's surface. That way, only a single satellite is needed for continuous service between two points on the surface, provided both points can be seen from the satellite. A combination of microwave, coaxial-cable, optical-fiber, and satellite paths now link the major cities of the world. The capacity of each type of system depends on its age and the territory covered, but capacities generally fall into the following ranges: Frequency modulation over a simple pair of wires like the earliest telephone lines yields tens of circuits (a circuit can transmit one telephone conversation) per pair; coaxial cable yields hundreds of circuits per pair of conductors, and thousands per cable; microwave and satellite transmissions yield thousands of circuits per link; and optical fiber has the potential for tens of thousands of circuits per fiber.

Computer-controlled exchange switches make it possible to offer a variety of extra services to both the residential and the business customer. Some services to which users may subscribe at extra cost are call waiting, in which a second incoming call, instead of receiving a busy signal, hears normal ringing while the subscriber hears a beep superimposed on the conversation in progress; and three-way calling, in which a second outgoing call may be placed while one is already in progress so that three subscribers can then talk to each other. Other services available to users are: caller ID, in which the calling party's number is displayed to the receiver on special equipment before the call is answered; and repeat dialing, in which a called number, if busy, will be automatically redialed for a certain amount of time. Of course users have the ability to block their name and phone from being displayed on a caller ID display. Another popular service is voice mail. While traditional answering machines cannot take a message if a caller is already on the line, voice mail creates a second virtual line. While a caller is talking to one party, a second incoming call is greeted with a message asking the second party to leave a message. The user will then be notified of the waiting message.

Unified messaging and the arrival of mobile Internet services means Short Message Service (SMS), a mobile messaging service, will soon become the primary alert mechanism for users to check and pick up their e-mail, fax or voice messages. The rapidly growing availability of WAP (Wireless Application Protocol) has enabled handsets to enhance the customer experience of reading and sending more messages. The arrival of the GSM (Global System for Mobile communications) family's next phase of evolution in the form of GPRS (General Packet Radio Services) will ensure faster speeds and boost the variety of mobile services available significantly. Mobile banking, M-Commerce, and customer service applications are also bolstering SMS traffic. The arrival of more advanced data services will yet again increase demand. During the First (1G) and Second (2G) Generations of mobile communications different regions of the world pursued different mobile phone standards. Europe pursued NMT and TACS for analog and GSM for digital. North America pursued AMPS for analog and a mix of TDMA, CDMA and GSM for digital. The Third Generation (3G), based on CDMA technology, will bring these incompatible standards together and allow convergence toward a common standard for mobile multimedia.

### SUMMARY OF THE INVENTION

A personal communication device that provides a user with voice and data communications, the communication device having a closed position wherein the device primarily provides voice communication and an open position wherein the device primarily provides data communication. The personal communication device includes a display screen, a first keypad and a second keypad. The display screen displays text and image information to the user, and is capable of displaying the information to the user in a first (vertical) orientation and in a second (horizontal) orientation. The display screen displays the information in the first orientation when the device is in the closed position and, in the second orientation when the device is in the open position.

The first keypad is attached to a bottom of the display screen when the device is in the vertical orientation, and the first keypad is permanently exposed for use by the user. The buttons in the first keypad allow the keypad to function as a numeric keypad when the device is operated in the first orientation and as the left half of a qwerty keyboard when the device is operated in the second orientation.

In the preferred embodiment, the second keypad is slide-ably attached to the back of the display screen and hidden behind the display screen when the device is in the closed position. The device can be moved to the open position by sliding the second keypad out from behind the screen so that the second keypad is exposed for use by the user. The second keypad provides the right half of the qwerty keyboard for use by the user. The device provides cellular telephone capabilities while in the closed position, and Internet capabilities while in the open position. The cellular telephone capabilities includes voice and text communications, and the Internet capabilities includes text and Internet communications.

The device also preferably includes a digital camera that is able to capture still and moving pictures, and the display screen is capable of displaying the pictures captured by the camera. The camera is able to rotate 180 degrees, so that the camera can face toward the user and can also face away from the user.

The device further comprises wireless data transmission applications that are compatible with the SIM Application Toolkit and the Wireless Application Protocol (WAP). The device supports the use of Short Message Service (SMS) and includes predictive text software. The device also preferably includes an Internet browser and, a musical interface program for downloading and playing music.

It is an object of the present invention to provide a personal communication device that supports cellular communications and Internet access.

It is another object of the present invention to provide a full qwerty keyboard to the user for typing text messages and accessing the Internet.

It is yet another object of the invention to provide a web enabled cellular telephone to the user that also includes gaming controls that allows the user to play video games on the device.

### BRIEF DESCRIPTION OF THE DRAWINGS

The invention of the present application will now be described in more detail with reference to the accompanying drawings, given only by way of example, in which:

FIG. 1 is a frontal view of the preferred embodiment in the closed position and in a vertical orientation;

FIG. 2 is a frontal view of the preferred embodiment in the open position and in a horizontal orientation;

FIG. 3 is view of the back of the preferred embodiment;

FIG. 4 is a side view of the preferred embodiment;

FIG. 5 is a frontal view of an alternate embodiment in the open position;

FIG. 6 is view of the back of the alternate embodiment;

FIG. 7 is another frontal view of the alternate embodiment;

FIG. 8 is a frontal view of a second alternate embodiment in the closed position;

FIG. 9 is a frontal view of the second alternate embodiment in the open position;

FIG. 10 is a side view of the second alternate embodiment;

FIG. 11 is frontal view of a third alternate embodiment in the closed position; and,

FIG. 12 is a frontal view of the third alternate embodiment in the open position.

### DETAILED DESCRIPTION OF THE INVENTION

FIG. 1 shows the preferred embodiment 100 of the present personal communication device that provides a user with voice, text and Internet communications. The present communication device includes a primary keypad 105 that has numbers, letters and symbols displayed in two different orientations. The numbers are displayed in their proper orientation when the device is in a vertical orientation, shown in FIG. 1, with the display screen 110 above the primary keypad 105 and the antenna 120 pointing upward. The present communication device is primarily used as a cellular telephone while in the vertical orientation, thus the numbers are presented to the user in the vertical orientation for easy recognition. The primary keypad 105 also displays letters in a second orientation. The letters in the primary keypad 105 include those letters found in the left half of a full sized “qwerty” keyboard. FIG. 1 shows the preferred embodiment 100 in its closed position. In the closed position the device operates in the first mode. In the first mode the numbers on the primary keypad 105 are enabled and the display screen 110 presents information to the user in the vertical orientation. The antenna 120 and digital camera 115 are actually attached to the top of a second keypad that is hidden behind the display screen 110.

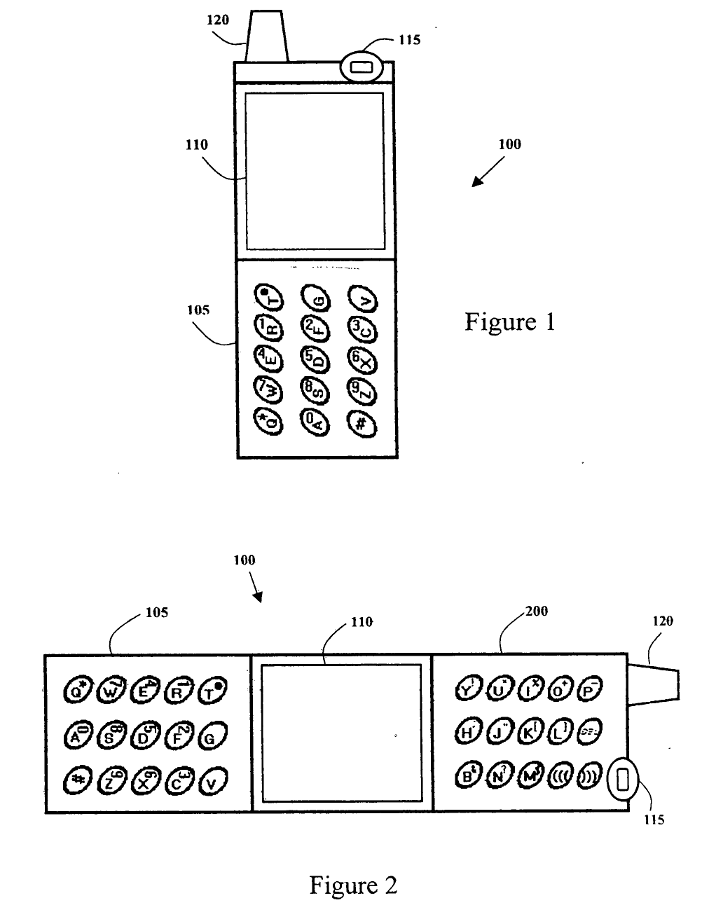

FIG. 2 shows the preferred embodiment 100 in the open position. In the open position the second keypad 200 is slid out from behind the display screen to expose the right half of a qwerty keyboard. The personal communication device is also rotated 90 degrees to the right so that it achieves a horizontal orientation. While in the open position the present communication device operates in a second mode, wherein the letters in the primary keypad 105 are enabled and the letters and symbols on the second keypad 200 are also enabled. The letters on the primary keyboard 105, and the letters and symbols on the second keypad 200 are both presented to the user in the horizontal orientation for easy text messaging and other data entry. When the device is in the closed position the display screen 110 displays information in the vertical orientation. However, when the device is in the open position the display screen 110 presents information to the user in the horizontal orientation, so that it can be easily read and understood by the user. When the user moves the device to the open position, text messaging and/or browser programs stored in the hardware of the device are called up and executed. The programs provide the user with enhanced text messaging capabilities and Internet browsing capabilities. The cellular telephone capabilities and the digital camera 115 are each operable in the both the open and closed positions.

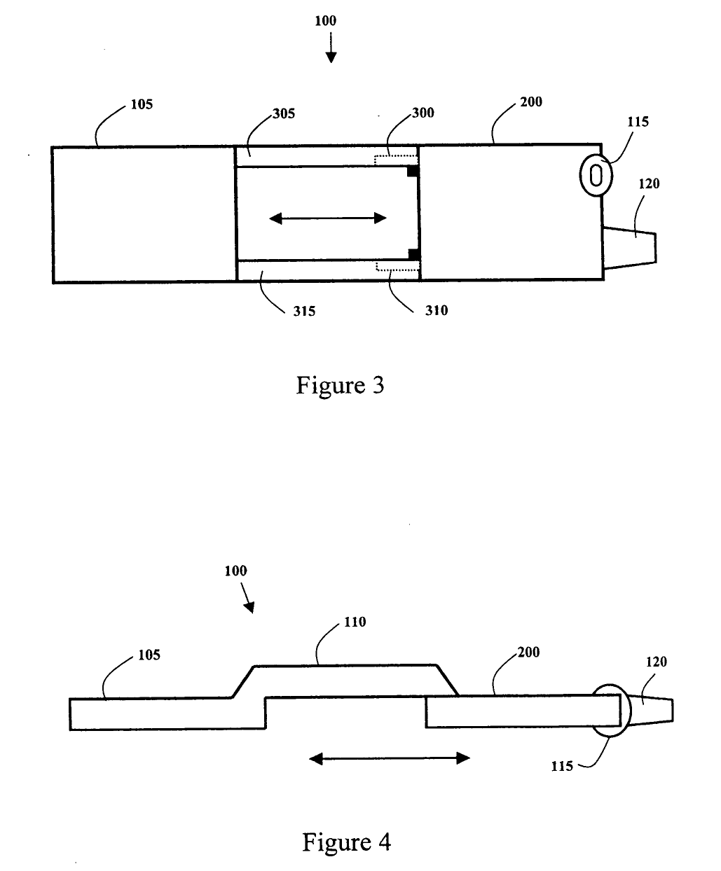

FIG. 3 shows the back of the preferred embodiment 100. FIG. 3 shows the sliding mechanism that allows the second keypad 200 to slide out from behind the display screen. FIG. 3 also illustrates that the digital camera 115 can rotate 180 degrees so that it can face the user and can also face away from the user. The second keypad 200 includes slides 300 and 310 that slide inside two tracks 305 and 315, respectively, that are attached to the back of the display screen. The slides 300 and 310 are mostly hidden from view and are slid within the primary keypad 105 when the device is moved to the closed position. Friction catches are preferably used to hold the slides in place while the device is in the open position, however other catches or latches can be used in other embodiments, including spring loaded catches.

FIG. 4 is a side view of the communication device showing that the display screen 110 is elevated above both the primary keypad 105 and the second keypad 200. The preferred embodiment 100 includes hardware and software for supporting Short Messaging Service (SMS), Multi-media Messaging Service (MMS), Instant Messaging (IM), Electronic Mail (e-mail), Bluetooth, Wi-Fi/Wi-Max, memory cards or sticks, and viewing of television.

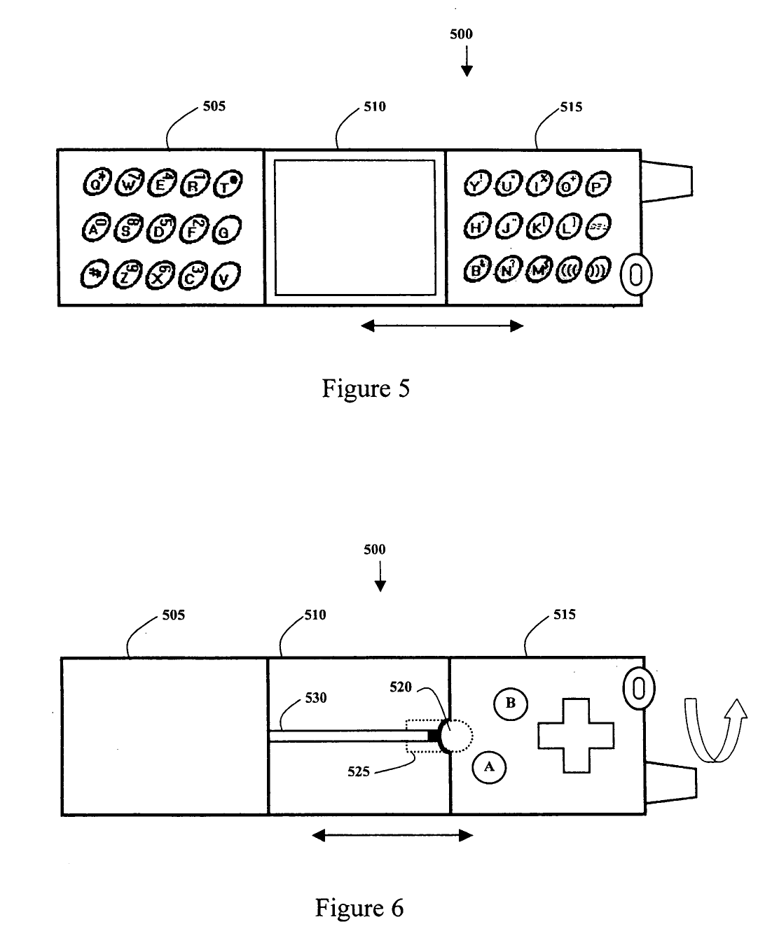

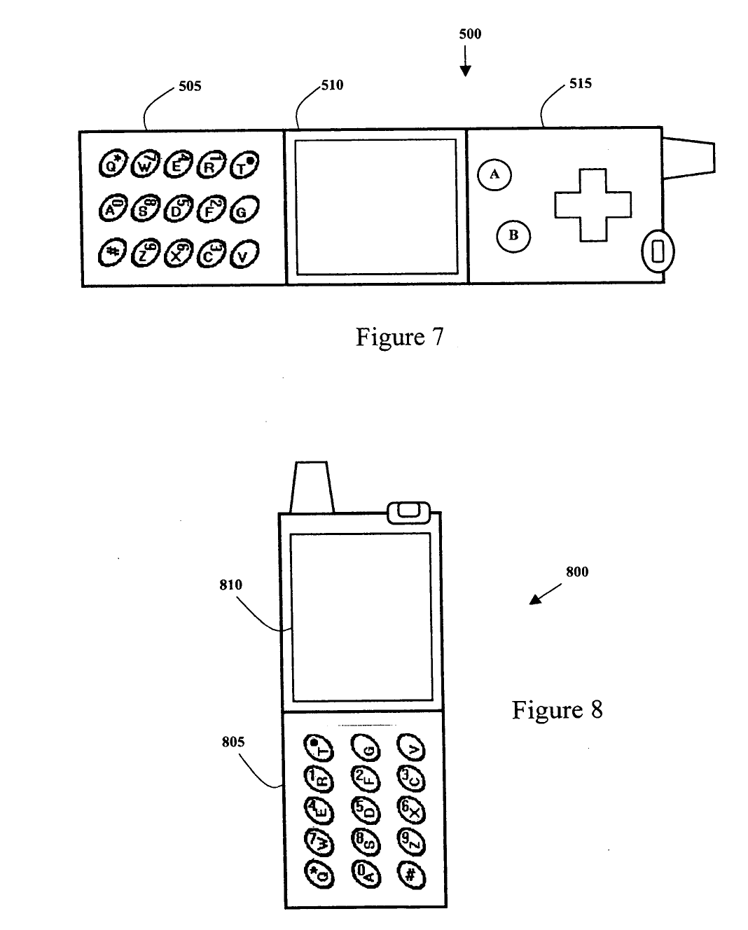

FIG. 5 is a frontal view of an alternative embodiment 500 of the present personal communication device. In FIG. 5, the device is in the open position and in the horizontal orientation. As in the preferred embodiment, when the alternative embodiment 500 is in the open position, with the primary keypad 505 to the left of the display screen 510 and the second keypad 515 to the right of the display screen, the device operates in the second mode. In the second mode, the letters on the primary keypad 505 are enabled and the letters and symbols on the front of second keypad 515 are also enabled. Also in the second mode, the gaming controls (shown in FIGS. 6 and 7) on the back of the second keypad 515 are disabled. When the user moves the device to the position shown in FIG. 5, text messaging and/or browser programs stored within the hardware of the device are automatically activated. The programs provide the user with enhanced text messaging capabilities and Internet browsing capabilities. When viewing the alternate embodiment 500 from the front, it looks very similar to the preferred embodiment shown in FIG. 2. The primary difference between the preferred and the alternate embodiments is shown in FIGS. 6 and 7.

FIG. 6 shows the back of the alternate embodiment 500. The sliding mechanism for this embodiment not only allows the second keypad 515 to slide out from behind the display screen 510, but also allows the second keypad 515 to rotate at least 180 degrees so that the gaming controls on the back of the second keypad 515 can face the user. The second keypad 515 includes a ball 520 around which the second keypad rotates. The ball 520 is attached to slides 525, which slide within groove 530 that extends down the center of the back of the display screen 510. Friction catches are preferably used to temporarily lock the slides 525 in place. Of course, other catches including spring-loaded catches may be used to lock the second keypad 515 in the open position. The device as shown in FIG. 6 is operated in the second mode and the gaming controls are disabled so that the user can apply pressure to the back of the second keypad 515 without causing unwanted actions. A cover may also optionally be provided to protect the exposed backside of the second keypad 515.

FIG. 7 shows the front of the alternate embodiment 500 after the second keypad 515 has been rotated 180 degrees so that the gaming controls are exposed for use by the user. When the gaming controls are rotated to the front of the device, the device automatically switches into a third operating mode. In the third mode, the keys displaying numbers and symbols on one side of the second keypad 515 are disabled and the gaming controls on the other side of the second keypad 515 are enabled. When the user rotates the gaming controls to the front of the device, gaming and/or browser programs stored in the hardware of the device are called up and made available to the user. The programs provide the user with self contained gaming, Internet gaming and Internet browsing capabilities. At least one of the buttons, in one of the two keypads, in the alternate embodiment 500 provides joystick capabilities to the user. The cellular telephone and digital camera capabilities are available to the user in all three modes in the alternate embodiment 500.

FIG. 8 is a frontal view of a second alternate embodiment 800 in the closed position, and vertical orientation. In the closed position the second alternate embodiment 800 operates in a first mode. The first mode facilitates use of the device as a cellular telephone, the numbers on the primary keypad 805 are enabled and information is presented to the user in the vertical orientation on the display screen 810.

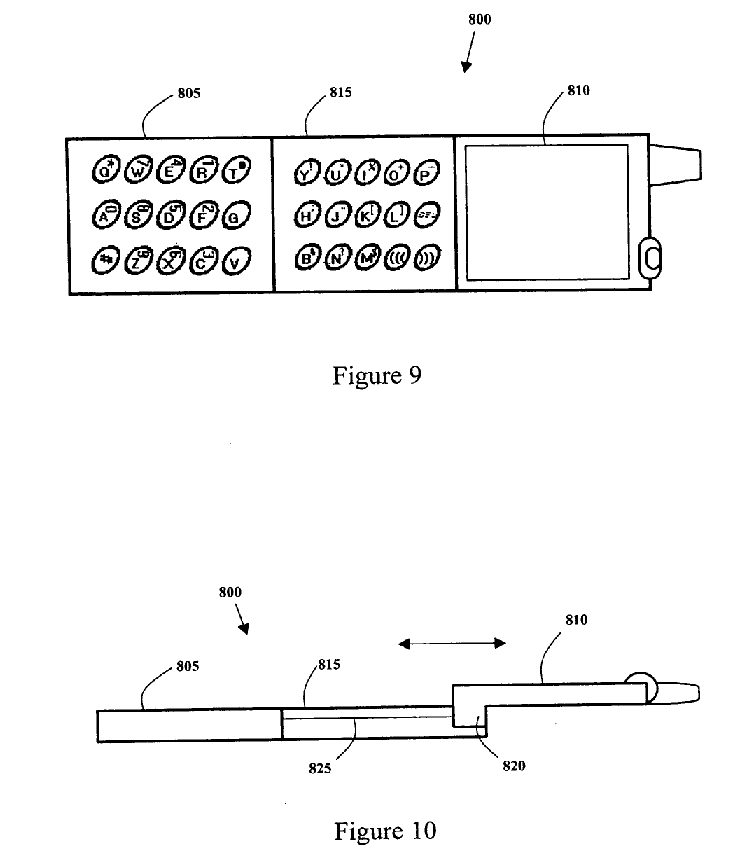

FIG. 9 shows the second alternate embodiment 800 in the open position, and in the horizontal orientation. In the open position the second alternate embodiment 800 operates in a second mode. The second mode facilitates use of the device as a text messaging assistant and Internet browser. In the second mode, the letters are enabled on the primary keypad 805, the second keypad 815 is enabled, and information is presented to the user in the horizontal orientation on display screen 810 for easy viewing. Also in the second mode, text messaging and/or browser programs within the communication device are executed that provide the user with enhanced text messaging capabilities and Internet browsing capabilities, respectively. The cellular telephone and digital camera capabilities are available to the user in both modes.

FIG. 10 is a side view of the second alternate embodiment 800 in the open position. In this embodiment, the display screen 810 slides out to move the device to the open position. Side extensions, including extension 820, slide within grooves, including groove 825, within the side edges of the second keypad 815. In embodiment 800 the primary keypad 805 and the second keypad 815 are adjacent to each other, which is intended to make typing on the keypads easier for some users.

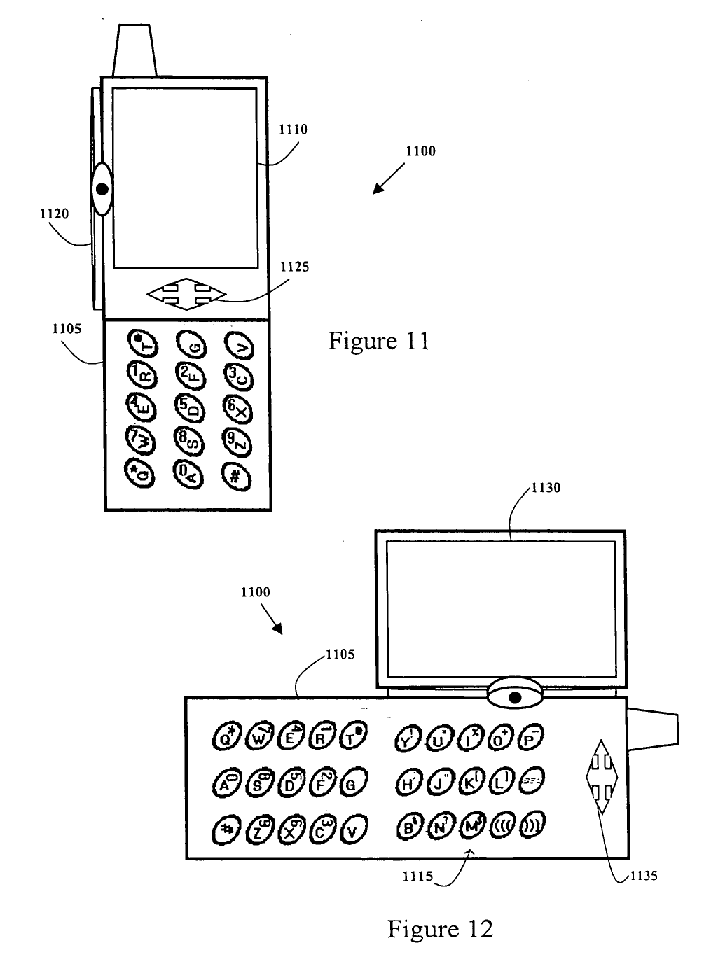

FIG. 11 is a frontal view of a third alternate embodiment 1100 of the present personal communication device, in the closed position and vertical orientation. This third alternate embodiment not only includes a hidden second keypad but also includes a hidden second screen, which is shown in FIG. 12. In the closed position the third alternate embodiment 1100 operates in a first mode. The first mode facilitates use of the device as a cellular telephone, the numbers on the primary keypad 1105 are enabled, and information is presented to the user in the vertical orientation on the first screen 1110. The first screen 1110 is rotate-ably connected to the communication device via hinge 1120. The primary keypad 1105 is accompanied on the front of the communication device by navigational keys 1125, which may also function as a joystick. Such navigational keys can be provided on all embodiments of the present personal communication device.

FIG. 12 shows the third alternate embodiment 1100 in the open position and in the horizontal orientation. After the entire device is rotated 180 degrees so that it achieves the horizontal orientation, the user lifts up the leading edge of the first screen 1110 to reveal: the second keypad 1115; the second set of navigation keys 1135; and, the second screen 1130. The second keypad 1115, together with the first keypad 1105 provide the user with a full continuous QWERTY keyboard. In the open position the third alternate embodiment 1100 operates in a second mode. The second mode facilitates use of the device as a text messaging assistant and Internet browser. In the second mode, the letters are enabled on the primary keypad 1105, the second keypad 1115 is enabled, and information is presented to the user in the horizontal orientation on the second screen 1130 for easy viewing. Also in the second mode, text messaging and/or browser programs within the communication device are executed that provide the user with enhanced text messaging capabilities and Internet browsing capabilities, respectively. The cellular telephone and digital camera capabilities are available to the user in both modes.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A personal communication device that provides a user with voice and data communications, the communication device having a closed position wherein the device primarily provides voice communication and an open position wherein the device primarily provides data communication, the personal communication device comprising:
a display screen for displaying text and image information to the user, wherein the display screen is capable of displaying the text and image information to the user in a first orientation and in a second orientation, with the display screen displaying the information in the first orientation when the device is in the closed position and, in the second orientation when the device is in the open position;
a first keypad, the first keypad being attached to a bottom of the display screen and being permanently exposed for use by the user, wherein the first keypad includes a first group of push-buttons, the first group of push-buttons displaying numbers and symbols for a numeric keypad in the first orientation and a first set of letters representing a left half of a qwerty keyboard in the second orientation; and,
a second keypad, the second keypad being slide-ably attached to a back portion of the display screen, wherein the second keypad is hidden behind the display screen when the device is in the closed position and, wherein the device can be moved to the open position by sliding the second keypad out from behind the screen so that the second keypad is exposed for use by the user, the second keypad having a second group of push-buttons, wherein the second set of push-buttons displays a second set of letters representing a right half of the qwerty keyboard in the second orientation, wherein the device provides cellular telephone capabilities while in the closed position, and Internet capabilities while in the open position.

2. The device of claim 1, wherein the cellular telephone capabilities includes voice and text communications, and wherein the Internet capabilities includes text and Internet communications.

3. The device of claim 1, further comprising a digital camera, the digital camera being able to capture still and moving pictures, wherein the display screen is capable of displaying the pictures captured by the camera, and further wherein the digital camera is able to rotate 180 degrees, so that the camera can face toward the user and can also face away from the user.

4. The device of 1, wherein the device further comprises wireless data transmission applications that are compatible with SIM Application Toolkit, Wireless Application Protocol (WAP), Bluetooth, Wi-Fi/Wi-Max and a TV tuner.

5. The device of claim 1, wherein the device is capable of using Short Message Service (SMS), Multi-media Messaging Service (MMS), Instant Messaging (IM), e-mail, and includes predictive text software.

6. The device of claim 1, wherein the device further comprises a set of navigational keys that provide navigating functions to the user, an Internet browser and, a musical interface program for downloading and playing music.

7. A personal communication and gaming device for wirelessly exchanging voice, text, image and gaming information, wherein the device is capable of functioning as a cellular telephone, a text messaging assistant, and a gaming toy, the device providing some functions while in a vertical orientation, defined by having a display screen above a first keypad, and providing other functions while in a horizontal orientation, which is achieved by rotating the device 90 degrees so that the display screen to a right of the first keypad, the personal communication and gaming device comprising:
cellular telephone circuitry for sending and receiving the voice, text, image and gaming information wirelessly;
gaming and control circuitry for storing and executing gaming and control programs;
the first keypad, the first keypad being attached to a bottom of the display screen when the device is in the vertical orientation, wherein the first keypad is permanently exposed for use by a user and includes a first group of keys that displays numbers and symbols for a numeric keypad in the vertical orientation, and the first group of keys also displays a first set of letters in the horizontal orientation, the first set of letters being letters in a left half of a qwerty keyboard, wherein the first group of keys function as the numeric keypad when the device is in a first mode and as the left half of the qwerty keyboard when the device is in a second mode, and further wherein the device is in the vertical orientation when operated in the first mode and in the horizontal orientation when operated in the second mode;
the display screen, wherein the display screen is capable of presenting the text and image information both in the vertical and in the horizontal orientations, wherein the information is presented in the vertical orientation when the device is in the first mode and in the horizontal orientation when the device is in the second mode;
a second keypad, the second keypad being slide-ably and rotate-ably attached to a back of the display screen, wherein the second keypad is hidden behind the display screen when the device is in the first mode and, wherein the device can be changed to the second mode by sliding the second keypad out from behind the screen so that the second keypad is fully exposed for use by the user, the second keypad having a front side and a back side, the front side having a second group of keys that display letters representing a right half of the qwerty keyboard, wherein the letters representing the right half of the qwerty keyboard are in the second orientation.

8. The device of claim 7, wherein the back side of the second keypad includes gaming controls for playing video games on the device, and the device is capable of operating in a third mode, wherein the device enters the third mode when the user twists the second keypad so that the gaming controls are facing the user.

9. The device of claim 7, further comprising a digital camera, the digital camera being able to capture still and moving pictures, wherein the display screen is capable of displaying the pictures captured by the camera, and further wherein the digital camera is able to rotate 180 degrees, so that the camera can face toward the user and can also face away from the user.

10. The device of 7, wherein the device further comprises wireless data transmission applications that are compatible with a SIM Application Toolkit and a Wireless Application Protocol (WAP), Bluetooth, Wi-Fi/Wi-Max, and a TV tuner.

11. The device of claim 7, wherein the device is capable of using Short Message Service (SMS), Multi-media Messaging Service (MMS), Instant Messaging (IM), e-mail, and includes predictive text software.

12. The device of claim 7, wherein the device further comprises a set of navigational keys that provide navigating functions to the user, an Internet browser and, a musical interface program for downloading and playing music.

13. A personal communication device that provides a user with voice and data communications, the communication device having a closed position wherein the device primarily provides voice communication and an open position wherein the device primarily provides data communication, the personal communication device comprising:
cellular telephone circuitry for sending and receiving voice and data information wirelessly;
messaging and control circuitry for storing and executing messaging and control programs;
a display screen for displaying text and image information to the user, wherein the display screen is slide-ably attached to the device and is capable of presenting the text and image information to the user in a vertical orientation and in a horizontal orientation, with the display screen presenting the information in the vertical orientation when the device is in the closed position and, in the horizontal orientation when the device is in the open position;
a set of navigational keys that provide navigational functions to the user wherein, the navigational keys are co-located with the display screen so that when the display screen is moved the navigational keys are also moved;
a first keypad, the first keypad located below the display screen when the device is in the vertical orientation and being permanently exposed for use by the user, wherein the first keypad includes a first group of keys, the first group of keys displaying numbers and symbols for a numeric keypad in the vertical orientation and also displaying a first set of letters representing a left half of a qwerty keyboard, the first set of letters being displayed in the horizontal orientation; and,
a second keypad, wherein the second keypad is hidden behind the display screen when the device is in the closed position and the device is moved to the open position by sliding the display screen off of the second keypad so that the second keypad is fully exposed and rotating the device 90 degrees to the right so that the display screen is located on a right side of the device, the second keypad comprising a second group of keys that displays letters and symbols from a right half of the qwerty keyboard, wherein the letters and symbols are displayed in the horizontal orientation.

14. The device of claim 13, further comprising a digital camera, the digital camera being able to capture still and moving pictures, wherein the display screen is capable of displaying the pictures captured by the camera, and further wherein the digital camera is able to rotate 180 degrees, so that the camera can face toward the user and can also face away from the user.

15. The device of 13, wherein the device further comprises wireless data transmission applications that are compatible with a SIM Application Toolkit and a Wireless Application Protocol (WAP).

16. The device of claim 13, wherein the device is capable of using Short Message Service (SMS), Multi-media Messaging Service (MMS), Instant Messaging (IM), e-mail, and includes predictive text software.

17. The device of claim 13, wherein the device further includes an Internet browser and, a musical interface program for downloading and playing music.

18. The device of claim 13, further comprising a second display screen and a second set of navigational keys, the second display screen being attached to a backside of the display screen and hidden from view while the device is in the closed position, wherein the display screen is rotate-ably attached to the device and is only capable of presenting the text and image information to the user in the vertical orientation, and further wherein the device is moved to the open position by rotating the display screen until the second keypad is accessible and the second display screen is easily visible by the user, the second display screen presenting the text and image information to the user while the device is in the open position.

19. The device of claim 18, further comprising a digital camera, the digital camera being able to capture still and moving pictures, wherein the display screen and the second display screen are each capable of displaying the pictures captured by the camera, and further wherein the digital camera is able to rotate 180 degrees, so that the camera can face toward the user and can also face away from the user.

20. The device of claim 18, wherein the device further comprises wireless data transmission applications that are compatible with SIM Application Toolkit and Wireless Application Protocol (WAP), and further wherein the device is capable of using Short Message Service (SMS), Multi-media Messaging Service (MMS), Instant Messaging (IM), e-mail, and includes predictive text software.
